(19) United States
(12) Patent Application Publication
(10) Pub. No.: US 2012/0148235 A1
(43) Pub. Date: Jun. 14, 2012

(54) CONTROL CIRCUIT, COMMUNICATION SYSTEM, AND CONTROL METHOD

(75) Inventors: Masato Nishihara, Kawasaki (JP); Tomoo Takahara, Kawasaki (JP); Toshiki Tanaka, Kawasaki (JP)

(73) Assignee: Fujitsu Limited, Kawasaki-shi (JP)

(21) Appl. No.: 13/315,560

(22) Filed: Dec. 9, 2011

(30) Foreign Application Priority Data
Dec. 13, 2010 (JP) 2010-277437

(51) Int. Cl. H04B 10/00; H04J 14/02; H04B 10/06; H04B 10/08

(52) U.S. Cl. 398/29; 398/140; 398/50; 398/82; 398/202

(57) ABSTRACT

A communication system includes a transmitter, a receiver device, and a control circuit. The transmitter transmits an optical signal. The receiver device receives the optical signal. The control circuit reduces a power consumption of the receiver device based on an accumulated chromatic dispersion of the received optical signal. The receiver device includes a receiver, an analog/digital converter, and a digital signal processor. The receiver extracts a signal indicating a complex amplitude of the optical signal. The analog/digital converter converts the signal indicating the complex amplitude into a digital signal. The digital signal processor digitally-processes the digital signal.

### CROSS-REFERENCE TO RELATED APPLICATIONS

This application is based upon and claims the benefit of priority of the prior Japanese Patent Application No. 2010-277437 filed on Dec. 13, 2010, the entire contents of which are incorporated herein by reference.

### FIELD

Embodiments discussed herein relate to a control circuit, a communication system, and a control method.

### BACKGROUND

In recent years, as transmission traffic has been increased, there has been a demand for introduction of an optical transmission system that has a transmission capacity of 40 [Gbit/s] or more. In contrast, there are various modulating methods with a higher spectral efficiency, a higher Optical Signal Noise Ratio (OSNR) tolerance, and a higher nonlinearity tolerance compared to the conventional Non Return to Zero (NRZ) modulating method.

For example, there is a Differential Quadrature Phase-Shift Keying (DQPSK) modulating method with a high chromatic dispersion tolerance, a high Polarization Mode Dispersion (PMD) tolerance, and a narrow spectrum.

As a technique for improving the characteristics (the OSNR tolerance and the chromatic dispersion tolerance), there is a digital coherent receiving method obtained by combining coherent reception and digital signal processing (for example, see the following Patent Document 1). There is a dispersion monitor provided in the digital coherent receiver with the digital coherent receiving method (for example, see the following Patent Document 2).

[Patent Document 1] U.S. Pat. No. 7,315,575.

[Patent Document 2] Japanese Laid-open Patent Publication No. 2010-130698.

However, there is a problem that the power consumption of the above-described conventional digital coherent receiver is high. For example, the power consumption and of a Digital Signal Processor of an Analog/Digital Converter (ADC) of the digital coherent receiver is especially high. Therefore, for example, the power consumption of the digital coherent receiver is several times higher than the power consumption of an optical receiver with the conventional direct detecting method (for example, 10 [Gbit/s]).

### SUMMARY

According to an aspect of the invention, a communication system includes a transmitter, a receiver device, and a control circuit. The transmitter transmits an optical signal. The receiver device receives the optical signal. The control circuit reduces a power consumption of the receiver device based on an accumulated chromatic dispersion of the received optical signal. The receiver device includes a receiver, an analog/digital converter, and a digital signal processor. The receiver extracts a signal indicating a complex amplitude of the optical signal. The analog/digital converter converts the signal indicating the complex amplitude into a digital signal. The digital signal processor digitally-processes the digital signal.

The object and advantages of the invention will be realized and attained via the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication system according to a first embodiment.

FIG. 2 is a diagram illustrating an example of a communication system according to a second embodiment.

FIG. 3 is a diagram illustrating an example of a digital coherent receiver.

FIG. 4 is a diagram illustrating an example of compensation processing of chromatic dispersion.

FIG. 5 is a flowchart illustrating an example of control processing by a control device according to the second embodiment.

FIG. 6A is a diagram (1) illustrating an example of a change procedure of path setting.

FIG. 6B is a diagram (2) illustrating another example of the change procedure of the path setting.

FIG. 6C is a diagram (3) illustrating another example of the change procedure of the path setting.

FIG. 7 is a graph illustrating a relation between an accumulated chromatic dispersion of an optical signal and a PAPR.

FIG. 8 is a graph illustrating a relation between the wavelength of the optical signal and the accumulated chromatic dispersion.

FIG. 9 is a graph illustrating a relation between the accumulated chromatic dispersion and a Q value penalty.

FIG. 10 is a diagram illustrating an example of a communication system according to a third embodiment.

FIG. 11 is a flowchart illustrating an example of the control processing by the control device according to the third embodiment.

FIG. 12 is a diagram illustrating an example of the communication system according to a fourth embodiment.

FIG. 13 is a flowchart illustrating an example of the control processing by the control device according to the fourth embodiment.

FIG. 14 is a diagram illustrating an example of the communication system according to a fifth embodiment.

FIG. 15 is a flowchart illustrating an example of the control processing by the control device according to a sixth embodiment.

FIG. 16 is a diagram illustrating an example of the communication system according to the sixth embodiment.

FIG. 17 is a flowchart (1) illustrating an example of the control processing by a control circuit according to the sixth embodiment.

FIG. 18 is a flowchart (2) illustrating another example of the control processing by the control circuit according to the sixth embodiment.

### DESCRIPTION OF EMBODIMENTS

With reference to the attached diagrams, embodiments will be described below.

### First Embodiment

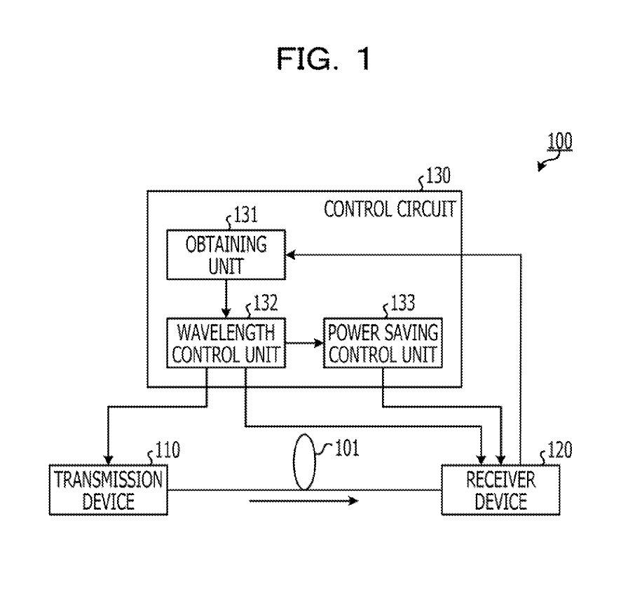

FIG. 1 is a diagram illustrating an example of the communication system according to a first embodiment. As illustrated in FIG. 1, a communication system 100 according to the first embodiment includes a transmission device 110, a receiver device 120, and a control circuit 130. The transmission device 110 transmits an optical signal through a transmission path 101. Furthermore, under the control of control circuit 130, the transmission device 110 changes a wavelength of the optical signal to be transmitted.

For example, a phase modulating method such as Phase Shift Keying, Differential PSK, Quadrature PSK, and Differential QPSK may be used as the modulating method of the optical signal transmitted from the transmission device 110. The optical signal transmitted from the transmission device 110 may be an optical signal that is polarization-multiplexed.

The receiver device 120 digital coherent-receives an optical signal that is transmitted from the transmission device 110 through the transmission path 101. For example, the receiver device 120 includes an optical receiver that extracts a signal indicating a complex amplitude of the optical signal, an analog/digital converter that converts an analog signal extracted by the optical receiver into a digital signal, and a digital signal processor that performs digital processing on the signal converted by the analog/digital converter. The digital signal processor may be operated by using a processor such as a Digital Signal Processor (DSP) and a Field-Programmable Gate Array (FPGA). The digital signal processor is operated in a substantially similar way in the other embodiments.

The optical receiver of the receiver device 120 includes, for example, an optical circuit that combines an optical signal with local oscillation light, and a photoelectric conversion unit that photoelectric-converts the optical signal, which is combined with the local oscillation light by the optical circuit. The digital signal processor of the receiver device 120 may monitor accumulated chromatic dispersion of the received optical signal. By digital filter processing, the digital signal processor of the receiver device 120 may reduce waveform distortion (for example, chromatic dispersion) of the signal converted by the analog/digital converter. For example, the optical circuit is a 90-degree hybrid circuit.

The control circuit 130 includes an obtaining unit 131, a wavelength control unit 132, and a power saving control unit 133. The obtaining unit 131 obtains the accumulated chromatic dispersion of the optical signal received by the receiver device 120. For example, the obtaining unit 131 obtains, from the receiver device 120, the dispersion information indicating the accumulated chromatic dispersion monitored by the receiver device 120. The obtaining unit 131 outputs the obtained dispersion information to the wavelength control unit 132. For example, the control circuit 130 may be operated by a program or the like using a processor and a Field-Programmable Gate Array (FPGA) as well as a circuit. The control circuit 130 is operated in a substantially similar way in the other embodiments.

The wavelength control unit 132 sets the wavelength of the optical signal, which is transmitted from the transmission device 110, to the wavelength of which the accumulated chromatic dispersion is transmitted from the transmission device 110, which is indicated by the dispersion information output from the obtaining unit 131, meets a prescribed condition. For example, the wavelength control unit 132 sets the wavelength of the optical signal transmitted from the transmission device 110 to the wavelength of which the amount of the accumulated chromatic dispersion is lower than a prescribed value.

Specifically, the wavelength control unit 132 monitors the accumulated chromatic dispersion while changing the wavelength of the optical signal transmitted from the transmission device 110 and sets the wavelength of the optical signal transmitted from the transmission device 110 when the amount of the accumulated chromatic dispersion is lower than the prescribed value. When setting the wavelength of the optical signal transmitted from the transmission device 110 to the wavelength of which the accumulated chromatic dispersion meets the prescribed condition, the wavelength control unit 132 outputs an instruction signal, which indicates that the power saving control is desired to be performed, to the power saving control unit 133.

The wavelength control unit 132 may set the wavelength of the local oscillation light of the receiver device 120 according to the wavelength set to the optical signal transmitted from the transmission device 110. For example, as the wavelength of the local oscillation light of the receiver device 120, the wavelength control unit 132 sets the wavelength that is substantially similar to the wavelength set to the optical signal transmitted from the transmission device 110 or the wavelength that is slightly changed from the wavelength set to the optical signal transmitted from the transmission device 110.

As a result, the receiver device 120 may receive the optical signal of which the wavelength is changed. However, the receiver device 120 detects a change of the wavelength of the optical signal transmitted from the transmission device 110 and sets the wavelength of the local oscillation light based on a detection result. In this case, the wavelength control unit 132 does not typically set the wavelength of the local oscillation light of the receiver device 120.

When the instruction signal is output from the wavelength control unit 132, the power saving control unit 133 performs control in such a way that the power consumption of the receiver device 120 is reduced. Specifically, the power saving control unit 133 performs the control in such a way that at least one of the analog/digital converter and the digital signal processor of the receiver device 120. For example, the power saving control unit 133 reduces the power consumption of the analog/digital converter by decreasing the number of bits (resolution) of the analog/digital converter of the receiver device 120. The number of bits of the analog/digital converter indicates, for example, a resolution of discretization (at least one of sampling and quantization) in digital conversion. Alternatively, the power saving control unit 133 may reduce the power consumption of the analog/digital converter by decreasing the number of filter stages of the digital filter processing of the receiver device 120.

Furthermore, the power saving control unit 133 obtains the dispersion information output from the obtaining unit 131 and controls the receiver device 120 based on the accumulated chromatic dispersion indicated by the obtained dispersion information. For example, correspondence information in which the accumulated chromatic dispersion corresponds to the number of bits is stored in a memory of the control circuit 130. The power saving control unit 133 obtains the number of bits corresponding to the accumulated chromatic dispersion from the correspondence information and sets the obtained number of bits to each analog/digital converter of the receiver device 120.

Alternatively, the correspondence information (for example, a relation expression or a table) in which the accumulated chromatic dispersion corresponds to the number of filter stages is stored in the memory of the control circuit 130. The power saving control unit 133 obtains the number of filter stages corresponding to the accumulated chromatic dispersion and sets the obtained number of filters to the digital filter processing of the receiver device 120.

For example, the control circuit 130 is provided in the receiver device 120. In this case, by transmitting, to the transmission device 110, the control signal indicating that the wavelength that meets the prescribed condition is desired to be set, the wavelength control unit 132 sets the wavelength of the optical signal transmitted from the transmission device 110. In this case, each of the control circuit 130 and the transmission devices 110 include a communication interface of an arbitrary communication method for transmitting and receiving control signals with each other.

Alternatively, the control circuit 130 may be provided in the transmission device 110. In this case, by transmitting the control signal indicating that the power consumption of the receiver device 120 is desired to be reduced to the receiver device 120, the power saving control unit 133 reduces the power consumption of the receiver device 120. The obtaining unit 131 receives the dispersion information from the receiver device 120. In this case, each of the receiver device 120 and the control circuit 130 includes an arbitrary communication interface of the communication method for transmitting and receiving the control signals with each other.

Alternatively, the control circuit 130 may be provided in a communication device other than the transmission device 110 and the receiver device 120. In this case, by transmitting the control signal indicating that the wavelength is desired to be set to meet the prescribed condition to the transmission device 110, the wavelength control unit 132 sets the wavelength of the optical signal transmitted from the transmission device 110. The power saving control unit 133 reduces the power consumption of the receiver device 120 by transmitting the control signal, which indicates that the power consumption of the receiver device 120 is desired to be reduced, to the receiver device 120. The obtaining unit 131 receives the dispersion information indicating the accumulated chromatic dispersion from the receiver device 120. In this case, each of the transmission device 110, the receiver device 120, and the control circuit 130 includes an arbitrary communication interface of the communication method for transmitting and receiving the control signals and the dispersion information with each other.

According to the first embodiment, the communication system 100 may set the wavelength of the optical signal transmitted from the transmission device 110 to the wavelength of which the accumulated chromatic dispersion of the optical signal received by the receiver device 120 meets the prescribed condition. The power consumption of the receiver device 120 may be reduced when the accumulated chromatic dispersion of the optical signal received by the receiver device 120 meets the prescribed condition. As a result, the power consumption of the receiver device 120 may be reduced while substantially suppressing the decrease of the transmission quality.

### Second Embodiment

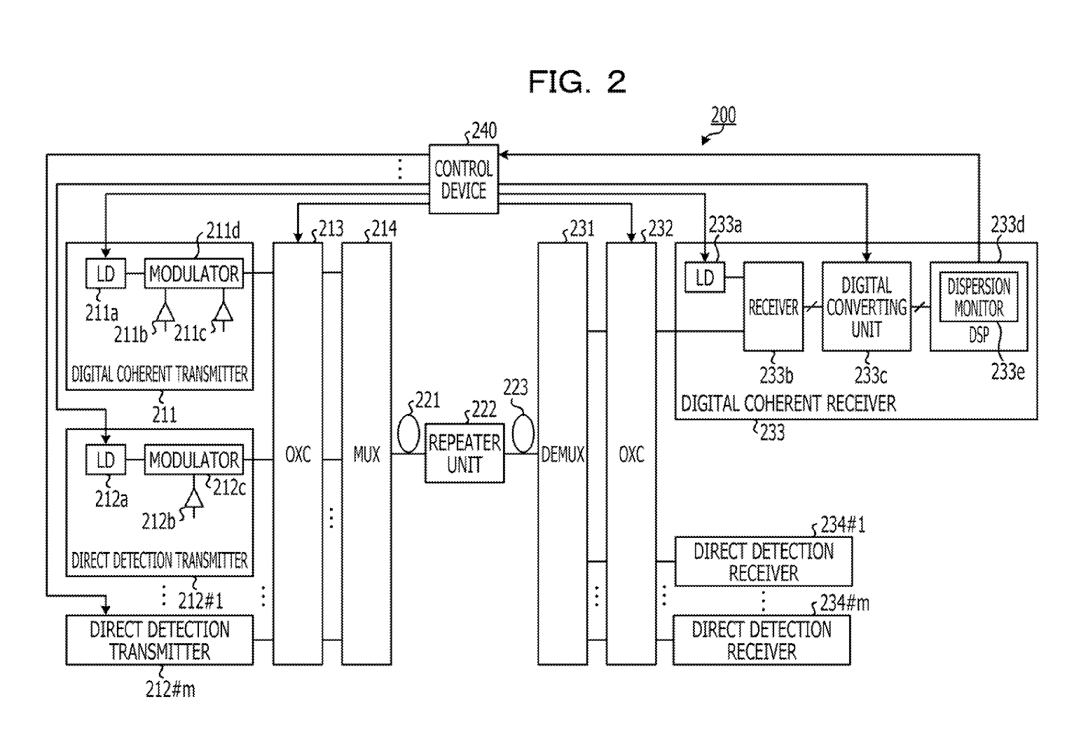

FIG. 2 is a diagram illustrating an example of the communication system according to a second embodiment. As illustrated in FIG. 2, a communication system 200 according to the second embodiment is a communication system in which there are a transceiver with the digital coherent method and a transceiver with the direct detecting method. Specifically, the communication system 200 includes a digital coherent transmitter (digital coherent TX) 211, a direct detection transmitters 212#1 to 212#m (m=1, 2, 3, etc.), an optical cross-connect (OXC) 213, a multiplexer (MUX) 214, a transmission path 221, a repeater unit 222, a transmission path 223, a demultiplexer (DEMUX) 231, an optical cross-connect (OXC) 232, a digital coherent receiver (digital coherent RX) 233, direct detection receivers 234#1 to 234#m, and a control device 240.

The digital coherent TX 211 is an example of the transmission device 110 illustrated in FIG. 1. The digital coherent TX 211 includes a Laser Diode (LD) 211a, drive units 211b and 211c, and a modulator 211d. The LD 211a generates and outputs a light to the modulator 211d. The LD 211a changes the wavelength of the light to be output by the control under the control device 240.

The drive units 211b and 211c output a data signal (an electronic signal) to the modulator 211d. The modulator 211d modulates the light output from the LD 211a with the data signal output from the drive units 211b and 211c. The modulator 211d outputs the modulated optical signal to the OXC 213. For example, a Mach-Zehnder (MZ) type LiNbO3 (LN) modulator or a semiconductor modulator may be used as the modulator 211d.

The direct detection TX 212#1 includes the LD 212a, the drive unit 212b, and the modulator 212c. The LD 212a generates and outputs a light to the modulator 212c. Under the control of the control device 240, the LD 212a changes the wavelength of the light to be output. The drive unit 212b outputs the data signal (the electronic signal) to the modulator 212c.

The modulator 212c modulates the light output from the LD 212a with the data signal output from the drive unit 212b. The modulator 212c outputs the modulated optical signal to the OXC 213. For example, a MZ-type LN modulator or a semiconductor modulator may be used as the modulator 212c. Each of the direct detecting transmitters 212#2 to 212#m has the configuration substantially similar to the direct detecting transmitter 212#1. The digital coherent TX 211 and the direct detecting transmitters 212#1 to 212#m output the optical signals with different wavelengths.

The OXC 213 is a first Optical Cross-Connect that has a plurality of input ports and a plurality of output ports. The optical signal transmitted from the digital coherent TX 211 and the light of which the wavelength is different from the wavelength of the optical signal transmitted from the digital coherent TX 211 are input into the plurality of input ports of the OXC 213. Specifically, the optical signal transmitted from the digital coherent TX 211 and the optical signals output from the direct detecting transmitters 212#1 to 212#m are input into the plurality of input ports of the OXC 213.

Each of the optical signals input into the plurality of input ports of the OXC 213 is output from one of the plurality of output ports of the OXC 213. The path of the optical signals in the OXC 213 is controlled by the control device 240. The lights output from the plurality of output ports of the OXC 213 are input into one of the input ports of the MUX 214.

The MUX 214 is coupled with the plurality of output ports of the OXC 213, respectively. The MUX 214 has a plurality of input ports corresponding to each wavelength (input ports with wavelength dependence). The MUX 214 wavelength-multiplexes each of the optical signals input into the plurality of input ports. The MUX 214 outputs the wavelength-multiplexed light. The wavelength-multiplexed light output from the MUX 214 is transmitted to the DEMUX 231 through the transmission path 221, the repeater unit 222, and the transmission path 223. The repeater unit 222 repeaters the wavelength-multiplexed light transmitted from the MUX 214 through the transmission path 221 and transmits the wavelength-multiplexed light to the DEMUX 231 through the transmission path 223.

The DEMUX 231 wavelength-demultiplexes the wavelength-multiplexed light transmitted from the MUX 214 through the transmission path 221, the repeater unit 222, and the transmission path 223. The MUX 214 includes a plurality of output ports corresponding to each wavelength. The transmission path 223 outputs the optical signals obtained by the wavelength-demultiplexing from the output port corresponding to the wavelengths of the optical signals, respectively.

The OXC 232 includes a plurality of input ports into which the optical signals output from the output ports of the DEMUX 231 are input, respectively. The OXC 232 is a second OXC that has the plurality of output ports that includes the output port coupled with the digital coherent RX 233.

The optical signals input into the plurality of input ports of the OXC 232 are output from one of the plurality of output ports of the OXC 232. The path of each of the optical signals in the OXC 232 is controlled by the control device 240. The lights output from the plurality of output ports of the OXC 232 are output to the digital coherent RX 233 and to one of the direct detecting receivers 234#1 to 234#m.

The digital coherent RX 233 is an example of the receiver device 120 illustrated in FIG. 1. The digital coherent RX 233 includes a Laser Diode (LD) 233a, a receiver 233b, a digital converting unit 233c, and a digital signal processor (DSP) 233d. The LD 233a is a Local Oscillator (LO) that generates and outputs a local oscillation light to the receiver 233b. The LD 233a changes the wavelength of the local oscillation light to be output under the control of the control device 240.

The receiver 233b is an optical receiver that extracts the signal indicating a complex amplitude of the optical signal. Specifically, the local oscillation light output from the LD 233a and the optical signal output from the OXC 232 are input into the receiver 233b. The receiver 233b combines the optical signal with the local oscillation light and photoelectric-converts the combined optical signal. The receiver 233b outputs the signal that is converted into an electronic signal to the digital converting unit 233c.

The digital converting unit 233c converts the signal output from the receiver 233b into a digital signal. The digital converting unit 233c outputs the signal that is converted into the digital signal to the DSP 233d. The digital converting unit 233c changes the number of bits (resolution) of the digital conversion under the control of the control device 240.

The DSP 233d receives the signal output from the digital converting unit 233c by the digital processing. For example, the DSP 233d demodulates the received signal by performing waveform distortion compensation based on the signal output from the digital converting unit 233c. The DSP 233d includes a function of a dispersion monitor 233e. By the digital processing based on the signal output from the digital converting unit 233c, the dispersion monitor 233e monitors the accumulated chromatic dispersion of the optical signal received by the digital coherent RX 233 and transmits the dispersion information indicating the monitored accumulated chromatic dispersion to the control device 240.

The dispersion monitor provided in the digital signal processor of the digital coherent receiver is described in the above-described Patent Document 2, for example. By the direct detecting method, each of the direct detection RXs 234#1 to 234#m receives the optical signal output from the OXC 232.

The control device 240 is an example of a communication device that includes the control circuit 130 illustrated in FIG. 1. The control device 240 receives the dispersion information transmitted from the dispersion monitor 233e of the digital coherent RX 233. The control device 240 transmits the control signal to the digital coherent TX 211 so that the wavelength of the LD 211a of the digital coherent receiver 211 is set to the wavelength of which the accumulated chromatic dispersion indicated by the received dispersion information meets the prescribed condition.

The control device 240 sets the wavelength of the LD 233a of the digital coherent RX 233 to the wavelength according to the wavelength that is set to the LD 211a. When the wavelength of the LD 211a of the digital coherent TX 211 is set, the control device 240 performs the control in such a way that the power consumption of the digital converting unit 233c is reduced by decreasing the number of bits of the digital converting unit 233c.

The communication system 200 may include a plurality of digital coherent transmitters 211 and digital coherent receivers 233. In the communication system 200, for example, the repeater unit 222 and the transmission path 223 may be omitted. In this case, the wavelength-multiplexed light output from the MUX 214 is transmitted to the DEMUX 231 through the transmission path 221.

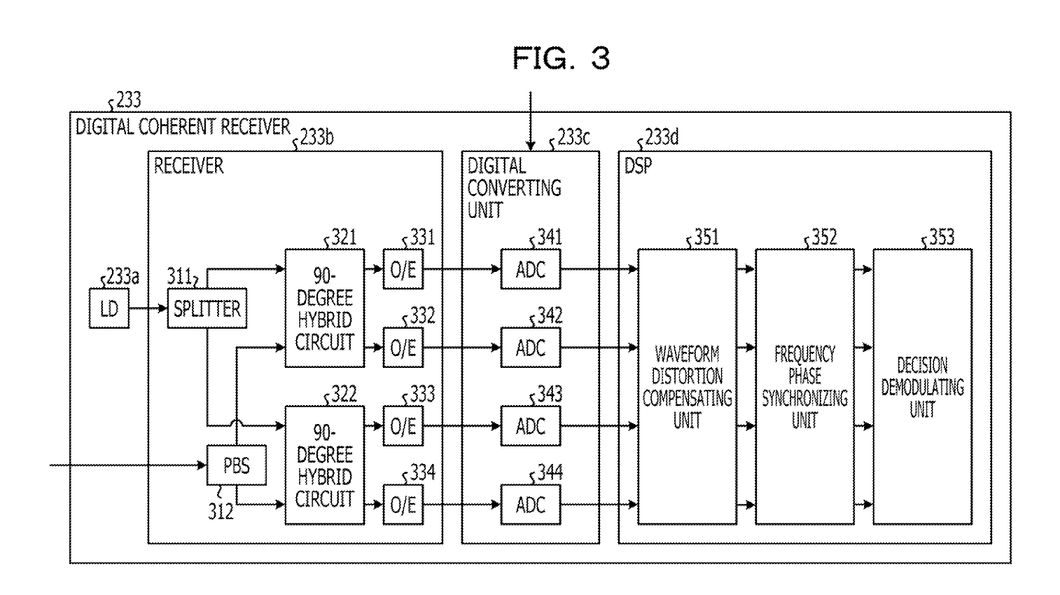

FIG. 3 is a diagram illustrating an example of the digital coherent receiver 233. The optical signal received by the digital coherent RX 233 is assumed to be an optical signal (four channels in total) obtained by polarization-multiplexing two optical signals that include an I channel (In phase) and a Q channel (Quadrature phase). As illustrated in FIG. 3, the receiver 233b of the digital coherent RX 233 includes a splitter 311, a Polarization Beam Splitter (PBS) 312, 90-degree hybrid circuits 321 and 322, and optical/electric converters (O/Es) 331 to 334.

The splitter 311 branches the local oscillation light output from the LD 233a and outputs the branched local oscillation light to the 90-degree hybrid circuits 321 and 322, respectively. The PBS 312 polarization-multiplexing splits the optical signal output from the OXC 232. The PBS 312 outputs the optical signal obtained by the polarization demultiplexing to the 90-degree hybrid circuits 321 and 322, respectively.

The 90-degree hybrid circuits 321 and 322 are optical circuits that combine the local oscillation light output from the splitter 311 with the optical signal output from the PBS 312. The 90-degree hybrid circuit 321 outputs the optical signals obtained by the combination to the O/Es 331 and 332, respectively. The 90-degree hybrid circuit 322 outputs the optical signals obtained by the combination to the O/Es 333 and 334, respectively.

Each of the O/Es 331 and 332 optical/electric-converts the optical signal output from the 90-degree hybrid circuit 321. Each of the O/Es 331 and 332 outputs the converted signal to the digital converting unit 233c. Each of the O/Es 333 and 334 optical/electric-converts the optical signal output from the 90-degree hybrid circuit 322. Each of the O/Es 333 and 334 outputs the converted signal to the digital converting unit 233c.

The digital converting unit 233c includes the ADCs 341 to 344. The ADCs 341 to 344 convert the signals output from the O/Es 331 to 334 into digital signals. Each of the analog/digital converters 341 to 344 outputs the signal that is converted into the digital signal to the DSP 233d. The digital converting unit 233c decreases the number of bits of the analog/digital converters 341 to 344 under the control of the control device 240.

The DSP 233d includes a waveform distortion compensating unit 351, a frequency phase synchronizing unit 352, and a decision demodulating unit 353. The waveform distortion compensating unit 351 compensates the waveform distortion of each of the signals output from the digital converting unit 233c. The waveform distortion compensated by the waveform distortion compensating unit 351 is a waveform distortion of the optical signal caused by, for example, waveform dispersion of the optical transmission path, polarization change, polarization mode dispersion, and the like. The waveform distortion compensating unit 351 outputs the signal of which the waveform distortion is compensated to the frequency phase synchronizing unit 352.

The frequency phase synchronizing unit 352 synchronizes the frequency and the phase of each of the signals output from the waveform distortion compensating unit 351 and outputs the signals to the decision demodulating unit 353. The decision demodulating unit 353 demodulates and decides each of the signals output from the frequency phase synchronizing unit 352. As a result, the optical signal input into the digital coherent RX 233 may be received. The decision demodulating unit 353 outputs a decision result of each of the signals.

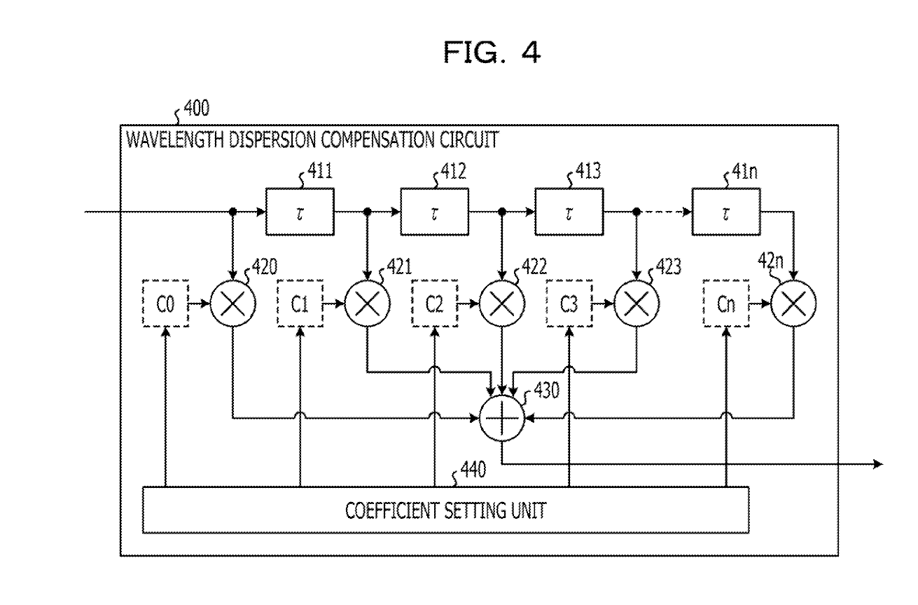

FIG. 4 is a diagram illustrating an example of compensating processing of the chromatic dispersion. A chromatic dispersion compensation circuit 400 illustrated in FIG. 4 illustrates processing of dispersion compensation performed by the waveform distortion compensating unit 351 illustrated in FIG. 3. The chromatic dispersion compensation circuit 400 is a Finite Impulse Response (FIR) of which the number of filter stages is n. Specifically, the chromatic dispersion compensation circuit 400 includes delay units 411 to 413, etc. to 41n, multiplying units 420 to 423, etc. to 42n, an addition unit 430, and a coefficient setting unit 440. The signal input into the chromatic dispersion compensation circuit 400 is input into the delay unit 411 and the multiplying unit 420.

The delay unit 411 delays the input signal by a delay amount τ and outputs the input signal to the delay unit 412 and the multiplying unit 421. The delay unit 412 delays the signal output from the delay unit 411 simply by the delay amount τ and outputs the signal to the delay unit 413 and the multiplying unit 422. The delay unit 413 delays the signal output from the delay unit 412 simply by the delay amount τ and outputs the signal to the delay unit in the latter stage and to the multiplying unit 423. The delay unit 41n delays the signal output from the delay unit in the early stage simply by the delay amount r and outputs the signal to the multiplying unit 42n.

The multiplying unit 420 multiplies the input signal by a coefficient C0 and outputs the signal to the addition unit 430. The multiplying unit 421 multiplies the signal output from the delay unit 411 by a coefficient C1 and outputs the signal to the addition unit 430. The multiplying unit 422 multiplies the signal output from the delay unit 412 by a coefficient C2 and outputs the signal to the addition unit 430. The multiplying unit 423 multiplies the signal output from the delay unit 413 by a coefficient C3 and outputs the signal to the addition unit 430. The multiplying unit 42n multiplies the signal output from the delay unit 41n by a coefficient Cn and outputs the signal to the addition unit 430.

The addition unit 430 adds the signals output from the multiplying units 420 to 423, etc. and 42n to the output signal. Based on the chromatic dispersion monitored by the dispersion monitor 233e (see FIG. 2), the coefficient setting unit 440 sets the coefficients C0 to Cn that are multiplexed by the multiplexing units 420 to 423, etc. and 42n. As a result, the chromatic dispersion of the signal input into the chromatic dispersion compensation circuit 400 may be reduced (compensated). The chromatic dispersion compensation circuit 400 may compensate larger chromatic dispersion if the number of filter stages, n, is larger.

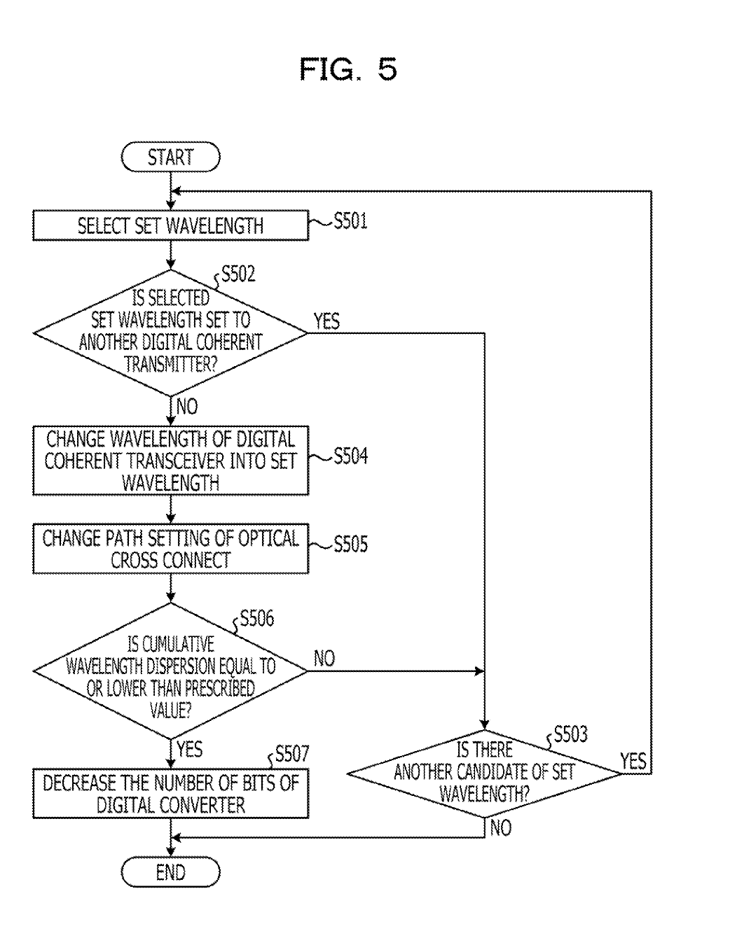

FIG. 5 is a flowchart illustrating an example of control processing by a control device according to the second embodiment. In this case, the communication system 200 includes a plurality of digital coherent transmitters 211 and a plurality of digital coherent receivers 233. The control device 240 performs operations illustrated in FIG. 5 on each pair of the digital coherent TX 211 and the coherent RX 233.

The control device 240 selects a set wavelength of a target digital coherent transceiver (the digital coherent TX 211 and the digital coherent RX 233) (Operation S501). The control device 240 determines whether or not the set wavelength selected in Operation S501 is already set to the digital coherent transceiver that is different from the target digital coherent transceiver (Operation S502).

In Operation S502, if the set wavelength is already set to another digital coherent transceiver (Yes in Operation S502), the control device 240 determines whether or not there is another set wavelength candidate that is different from the set wavelength selected in Operation S501 (Operation S503). If there is no set wavelength candidate (No in Operation S503), the control device 240 ends the sequence processing. In this case, the number of bits of the digital converting unit 233c is not changed. If there is another set wavelength candidate (Yes in Operation S503), the control device 240 goes back to Operation S501 to select another set wavelength candidate.

In Operation S502, if the wavelength is not set to another digital coherent transceiver (No in Operation S502), the control device 240 goes to Operation S504. That is, the control device 240 changes the wavelength of the target digital coherent transceiver into the set wavelength selected in Operation S501 (Operation S504). Specifically, the control device 240 changes the wavelengths of the LD 211a of the target digital coherent TX 211 and of the LD 233a of the target digital coherent RX 233, respectively. If the set wavelength is not set another digital coherent transceiver, the set wavelength may be set to the optical transceiver of the direct receiving method. In this case, the control device 240 may perform the control in such a way that the wavelength that is set to the target digital coherent transceiver is set to another wavelength.

The control device 240 changes the path setting of the OXCs 213 and 232 (Operation S505). Specifically, the control device 240 changes the path setting of the OXC 213 in such a way that the optical signal output from the target digital coherent TX 211 is input into the input port corresponding to the changed set wavelength among the input ports of the MUX 214. The control device 240 changes the path setting of the OXC 232 in such a way that the optical signal output from the output port corresponding to the changed set wavelength among the output ports of the DEMUX 231 is input into the target digital coherent RX 233.

The control device 240 determines whether or not the accumulated chromatic dispersion of the optical signal received by the target digital coherent RX 233 is lower than a prescribed value (for example, ±500 [ps/nm]) (Operation S506). Specifically, the control device 240 determines whether or not the accumulated chromatic dispersion indicated by the dispersion information output from the dispersion monitor 233e of the target digital coherent RX 233 is lower than the prescribed value. If the accumulated chromatic dispersion is not lower than the prescribed value (No in Operation S506), the control device 240 goes to Operation S503.

In Operation S506, if the accumulated chromatic dispersion is lower than the prescribed value (Yes in Operation S506), the control device 240 decreases the number of bits of the analog/digital converter of the target digital coherent RX 233 (Operation S507), and the sequence processing ends. In Operation S507, the control device 240 decreases the number of bits of the analog/digital converters 341 to 344 of the digital converting unit 233c of the target digital coherent RX 233.

According to the above-described Operations, the wavelength of the optical signal transmitted from the digital coherent TX 211 is set to the wavelength of which the accumulated chromatic dispersion of the optical signal received by the digital coherent transmitter 233 is lower than the prescribed value. The power consumption of the digital coherent RX 233 may be reduced while the accumulated chromatic dispersion of the optical signal received by the digital coherent RX 233 is lower than the prescribed value.

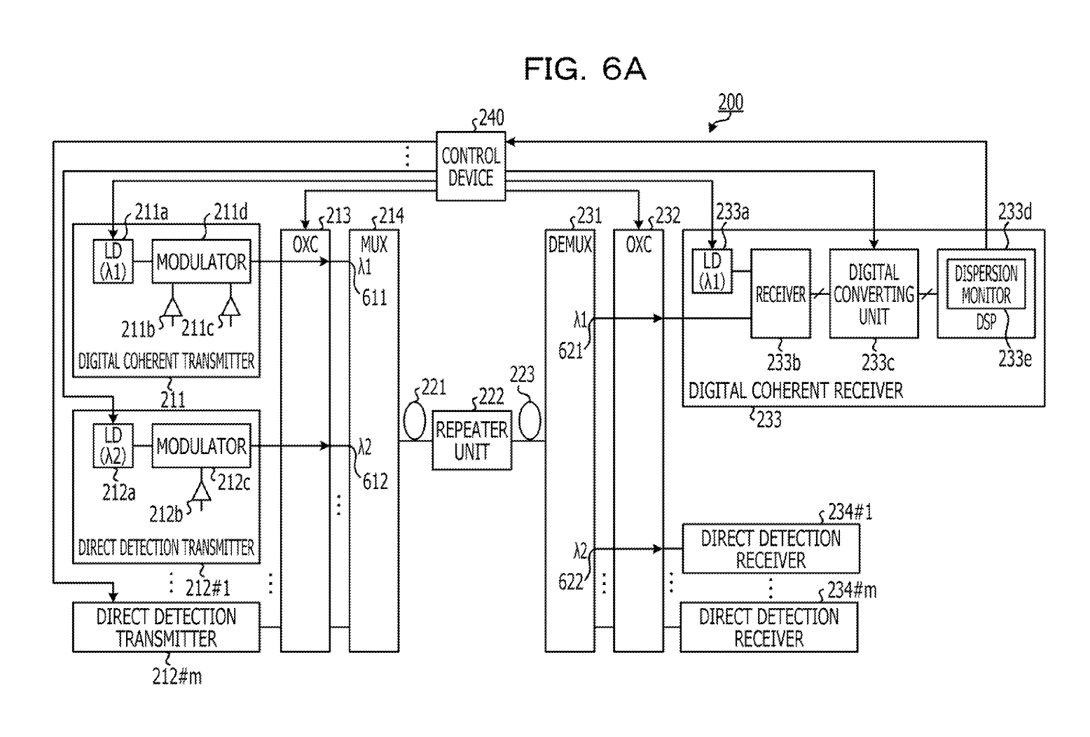

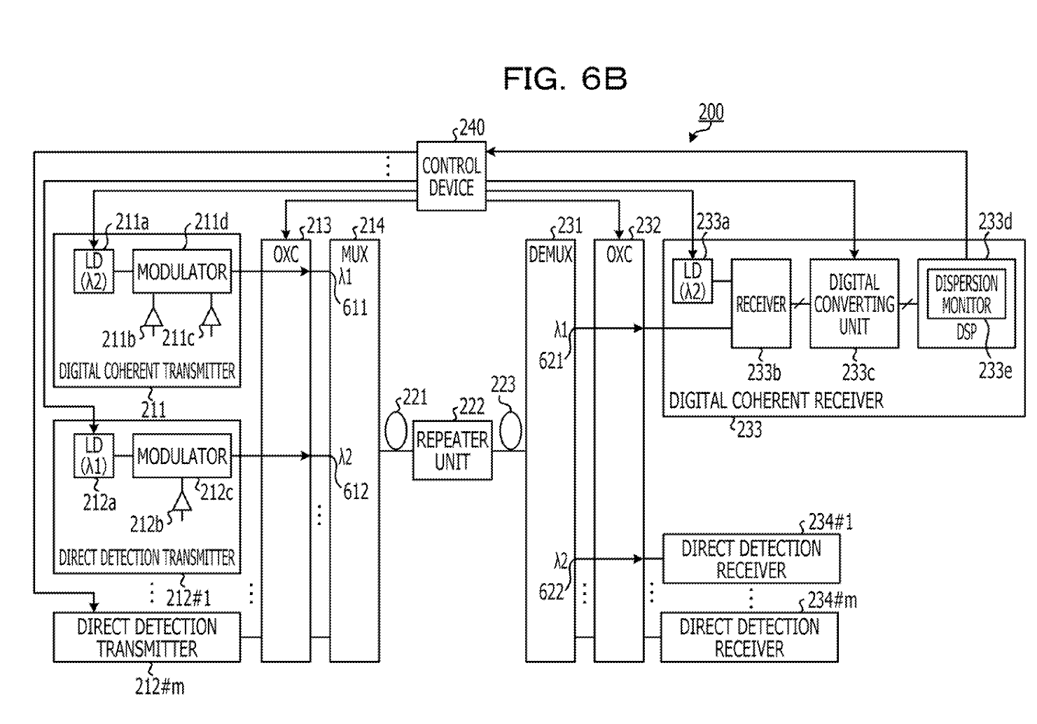

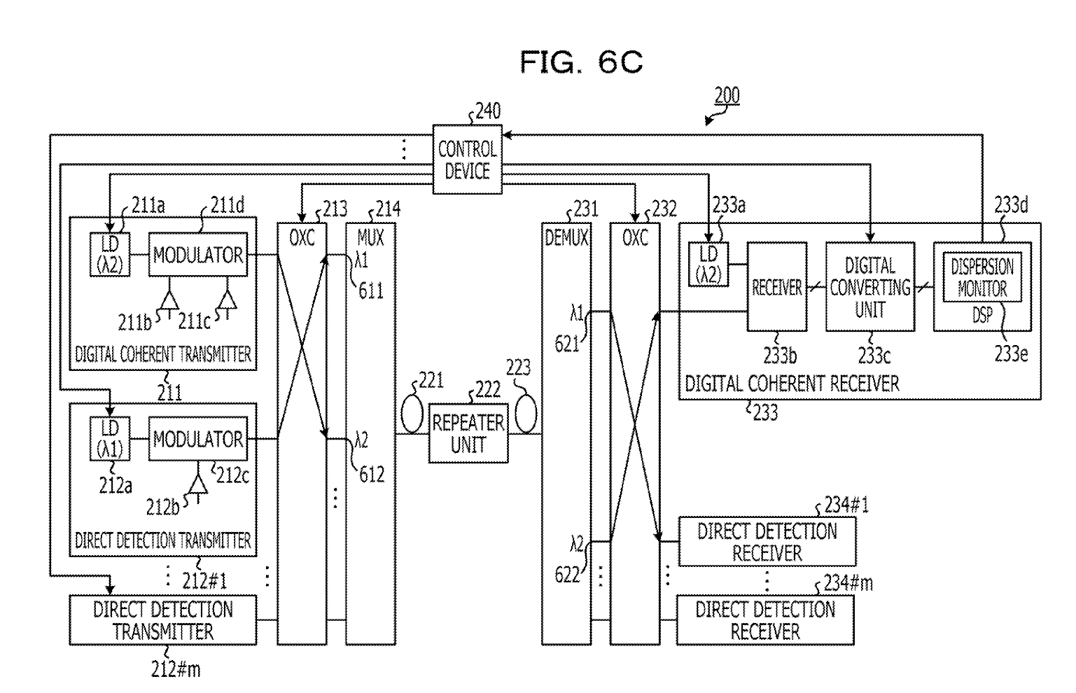

FIGS. 6A to 6C are diagrams illustrating examples of change procedures of the path setting. In FIGS. 6A to 6C, the components substantially similar to those components of FIG. 2 are indicated by the similar numerals, so that the description is omitted. Before the control processing illustrated in FIG. 5, as illustrated in FIG. 6A, the LDs 211a and 233a are set to a wavelength λ1, and the LD 212a is set to a wavelength λ2.

The OXC 213 is set in such a way that the optical signal of the wavelength λ1 output from the digital coherent TX 211 is input into the input port corresponding to the wavelength λ1 of the MUX 214. The OXC 213 is set in such a way that the optical signal with the wavelength λ2 output from the direct detecting transmitter 212#1 is input into the input port 612 corresponding to the wavelength λ2 of the MUX 214.

The OXC 232 is set in such a way that the optical signal of the wavelength λ1 output from the output port 621 corresponding to the wavelength λ1 of the DEMUX 231. The OXC 232 is set in such a way that the optical signal with the wavelength λ2 output from the output port 622 corresponding to the wavelength λ2 of the DEMUX 231 is output to the direct detecting receiver 234#1.

In Operation S504 illustrated in FIG. 5, as illustrated in FIG. 6B, the LDs 211a and 233a are set to the wavelength λ2. At this time, since the wavelength λ2 is set to the LD 212a, the wavelength of the LD 212a is set to, for example, the wavelength λ1. As a result, the optical signals from the digital coherent TX 211 and the direct detecting transmitter 212#1 do not have the similar wavelengths.

In Operation S505 illustrated in FIG. 5, as illustrated in FIG. 6C, the OXC 213 is set in such a way that the optical signal with the wavelength λ2 from the digital coherent TX 211 is input into the input port 612 corresponding to the wavelength λ2 of the MUX 214. The OXC 213 is set in such a way that the optical signal with the wavelength λ1 from the direct detecting transmitter 212#1 is input into the input port 611 corresponding to the wavelength λ1 of the MUX 214.

The OXC 232 is set in such a way that the optical signal with the wavelength λ1 output from the output port 621 corresponding to the wavelength λ1 of the DEMUX 231 is output to the direct detecting receiver 234#1. The OXC 232 is set in such a way that the optical signal with the wavelength λ2 output from the output port 622 corresponding to the wavelength λ2 of the DEMUX 231 is output to the digital coherent RX 233.

As a result, even if the wavelength of the optical signal transmitted from the digital coherent TX 211 is changed in the communication system 200 of the wavelength multiplexing method, the optical signal transmitted from the digital coherent TX 211 may be transmitted to the digital coherent RX 233.

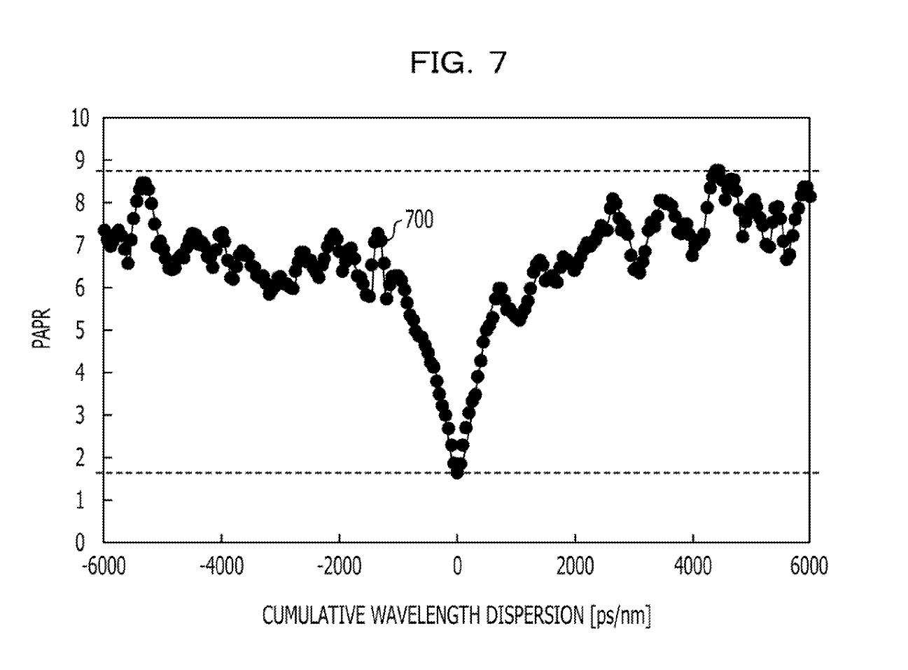

FIG. 7 is a graph illustrating a relation between the accumulated chromatic dispersion and a Peak-to-Average Power Ratio (PAPR) of the optical signal. In FIG. 7, the transverse axis indicates the accumulated chromatic dispersion [ps/nm] of the optical signal received by the digital coherent RX 233. On the other hand, the vertical axis indicates the PAPR of the optical signal received by the digital coherent RX 233. A PAPR characteristic 700 indicates a characteristic of the PAPR corresponding to the accumulated chromatic dispersion of the optical signal received by the digital coherent RX 233.

As indicated by the PAPR characteristic 700, the PAPR is decreased if the accumulated chromatic dispersion is closer to 0. In particular, the PAPR is considerably decreased within the range in which the accumulated chromatic dispersion is ±800 [ps/nm]. Regarding the digital coherent receiving method, the number of bits of the analog/digital converter is desired to be increased, and the resolution is desired to be increased to receive the reception signal with a higher PAPR. The power consumption is increased as the number of bits of the analog/digital converter is increased.

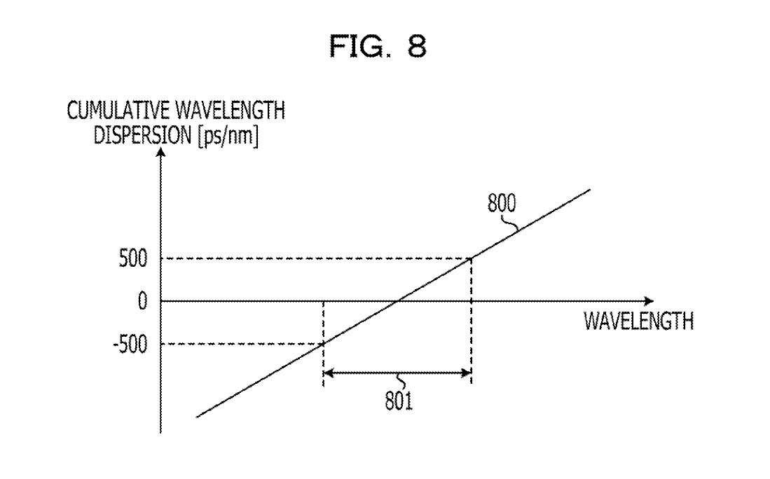

FIG. 8 is a graph illustrating a relation between the wavelength of the optical signal and the accumulated chromatic dispersion. In FIG. 8, the transverse axis indicates the wavelength of the optical signal transmitted from the digital coherent TX 211. On the other hand, the vertical axis indicates the accumulated chromatic dispersion of the optical signal that is transmitted from the digital coherent TX 211 and received by the digital coherent RX 233. An accumulated chromatic dispersion characteristic 800 indicates a simplified example of the characteristic of the accumulated chromatic dispersion corresponding to the wavelength of the optical signal.

As illustrated with the accumulated chromatic dispersion characteristic 800, if the wavelength of the optical signal transmitted from the digital coherent TX 211 changes, the accumulated chromatic dispersion of the optical signal received by the digital coherent RX 233 changes. Therefore, if the wavelength of the optical signal transmitted from the digital coherent TX 211 is controlled, the accumulated chromatic dispersion of the optical signal received by the digital coherent RX 233 may be suppressed.

For example, if the wavelength of the optical signal transmitted from the digital coherent TX 211 is set to the wavelength range 801, the accumulated chromatic dispersion may be suppressed to be within the range ±500 [ps/nm]. Since the PAPR of the optical signal received by the digital coherent RX 233 (see FIG. 7) may be suppressed, the decrease of the transmission quality is substantially prevented even if the number of bits of the analog/digital converter is decreased. As a result, the power consumption of the digital coherent RX 233 may be reduced.

According to the digital coherent receiving method, the large accumulated chromatic dispersion may be compensated by the digital processing. Conventionally, regarding the digital coherent receiving method, the accumulated chromatic dispersion does not cause a big problem, so that the wavelength allocation of the optical signal is not considered. On the other hand, in the communication system 200, if the accumulated chromatic dispersion of the optical signal is substantially suppressed by controlling the wavelength of the optical signal, the power consumption may be reduced.

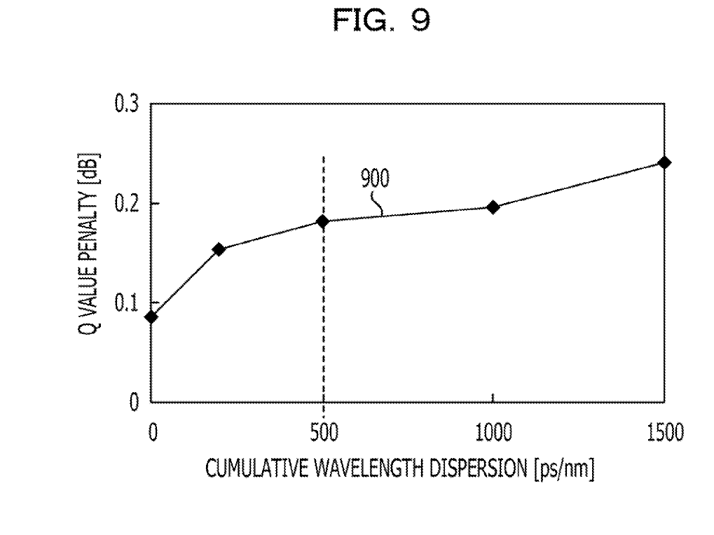

FIG. 9 is a graph illustrating a relation between the accumulated chromatic dispersion and a Q value penalty caused by decreasing the number of bits. In FIG. 9, the transverse axis indicates the accumulated chromatic dispersion [ps/nm] of the optical signal received by the digital coherent RX 233. The vertical axis indicates the Q value penalty [dB] caused by decreasing the number of bits of the analog/digital converters 341 to 344 from 5 bits to 4 bits. The Q value penalty characteristic 900 indicates the characteristic of the Q value characteristic with respect to the accumulated chromatic dispersion.

If the accumulated chromatic dispersion of the optical signal is increased, the PAPR of the optical signal is increased. Thus, as indicated with the Q value penalty characteristic 900, the Q value penalty caused by decreasing the number of bits is increased. On the other hand, if the wavelength of the optical signal transmitted from the digital coherent TX 211 is controlled, and the amount of the accumulated chromatic dispersion of the optical signal is equal to or lower than 500 [ps/nm], the Q value penalty may be suppressed lower than 0.2 [dB] caused by the decrease of the number of bits. Therefore, the power consumption of the digital coherent RX 233 may be reduced by suppressing the decrease of the reception quality of the digital coherent RX 233 and decreasing the number of bits of the analog/digital converters 341 to 344. For example, in a case of a flash-type analog/digital converter, the power consumption may be reduced by half by decreasing the number of bits by 1 bit.

According to the communication system 200 of the second embodiment, the wavelength of the optical signal transmitted from the digital coherent TX 211 may be set to the wavelength of which the amount of the accumulated chromatic dispersion of the optical signal received by the digital coherent receiver 233 is equal to or lower than the prescribed value. The number of bits of the analog/digital converters 341 to 344 may be decreased in a state in which the amount of the accumulated chromatic dispersion of the optical signal received by the receiver device 120 is lower than the prescribed value. As a result, the power consumption of the digital coherent RX 233 may be reduced while the decrease of the transmission quality is substantially suppressed.

### Third Embodiment

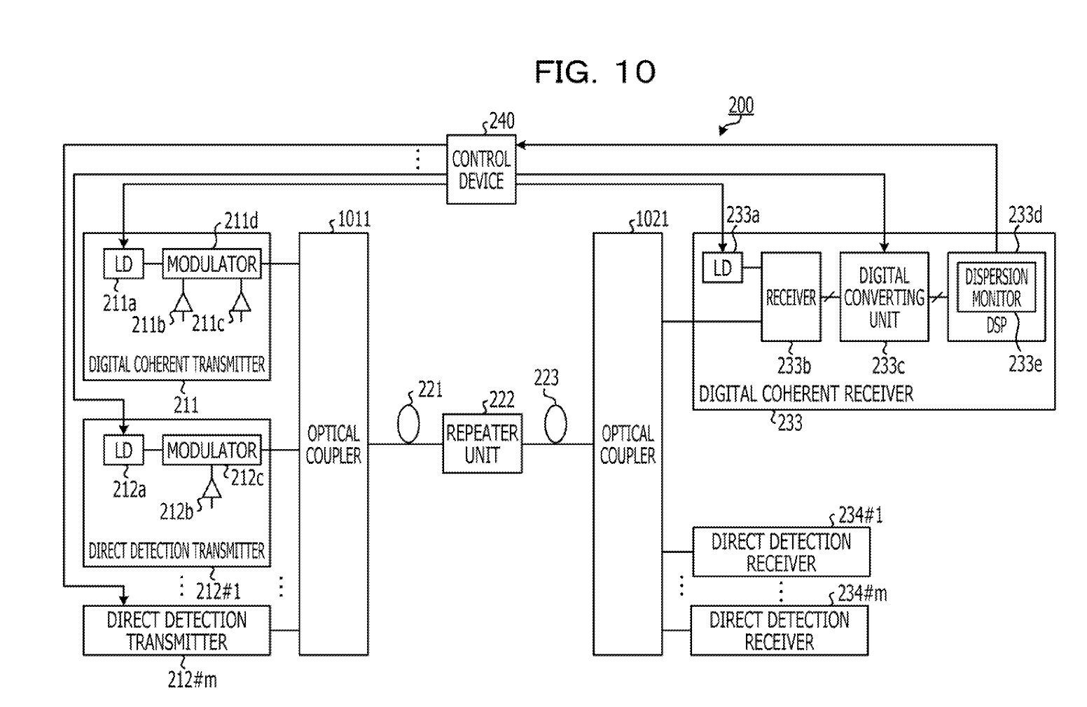

FIG. 10 is a diagram illustrating an example of a communication system according to a third embodiment. In FIG. 10, the components substantially similar to the components of FIG. 2 are indicated by the similar numerals, so that the description is omitted. As illustrated in FIG. 10, a communication system 200 according to the third embodiment includes the OXCs 213 and 232 illustrated in FIG. 2 and optical couplers 1011 and 1021 instead of the MUX 214 and the DEMUX 231.

The optical coupler 1011 is a first optical coupler that multiplexes the optical signals output from the digital coherent TX 211 and the direct detection transmitters 212#1 to 212#m. The optical signals output from the digital coherent TX 211 and the direct detection transmitters 212#1 to 212#m have different wavelengths and are wavelength-multiplexed by the optical coupler 1011. The optical coupler 1011 outputs the wavelength-multiplexed light. The wavelength-multiplexed light output from the optical coupler 1011 is transmitted to the optical coupler 1021 through the transmission path 221, the repeater unit 222, and the transmission path 223.

The optical coupler 1021 is a second optical coupler that branches (power branches) the wavelength-multiplexed light transmitted from the optical coupler 1011 through the transmission path 221, the repeater unit 222, and the transmission path 223. The optical coupler 1021 outputs the branched wavelength-multiplexed light to the digital coherent RX 233 and the direct detecting receivers 234#1 to 234#m, respectively. Each of the digital coherent RX 233 and the direct detection receivers 234#1 to 234#m extracts and receives one of the optical signals of each wavelength included in the wavelength-multiplexed light output from the optical coupler 1021.

In this case, the communication system 200 includes the optical couplers 1011 and 1021 instead of the OXCs 213 and 232, the MUX 214, and the DEMUX 231. However, the configuration is not limited to the above-described configuration. For example, the communication system 200 may have a configuration with the optical coupler instead of the MUX 214 and the DEMUX 231. In this case, the control device 240 performs the path setting of the OXC 232 (for example, see FIG. 6C). The communication system 200 may include the optical coupler 1021 instead of the OXC 232 and the DEMUX 231 illustrated in FIG. 2. In this case, the control device 240 performs the path setting of the OXC 213 (for example, see FIG. 6C).

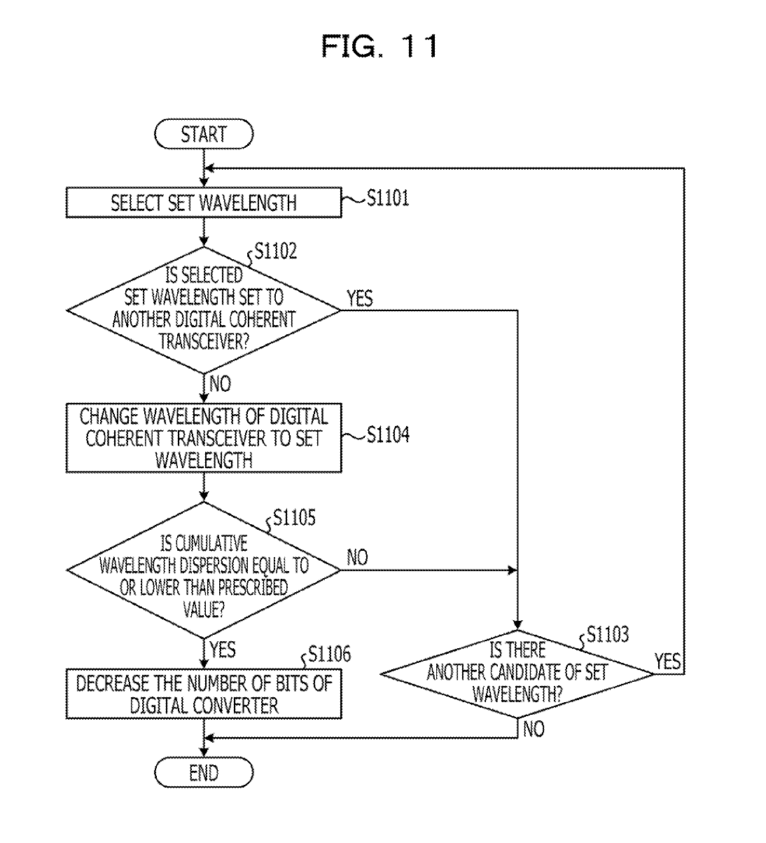

FIG. 11 is a flowchart illustrating an example of the control processing by the control device according to the third embodiment. For example, the control device 240 performs Operations illustrated in FIG. 11 on the pair of the digital coherent TX 211 and the digital coherent RX 233. Operations S1101 to S1104 illustrated in FIG. 11 are substantially similar to Operations S501 to S504 illustrated in FIG. 5. After Operation S1104, the control device 240 goes to Operation S1105. Operations S1105 and S1106 are substantially similar to Operations S506 and S507 illustrated in FIG. 5. As described above, according to the communication system 200 of the third embodiment, the path setting processing of the OXCs 213 and 232 illustrated in FIG. 2 and FIG. 6C may be omitted by achieving the wavelength multiplexing method using the optical couplers 1011 and 1021.

### Fourth Embodiment

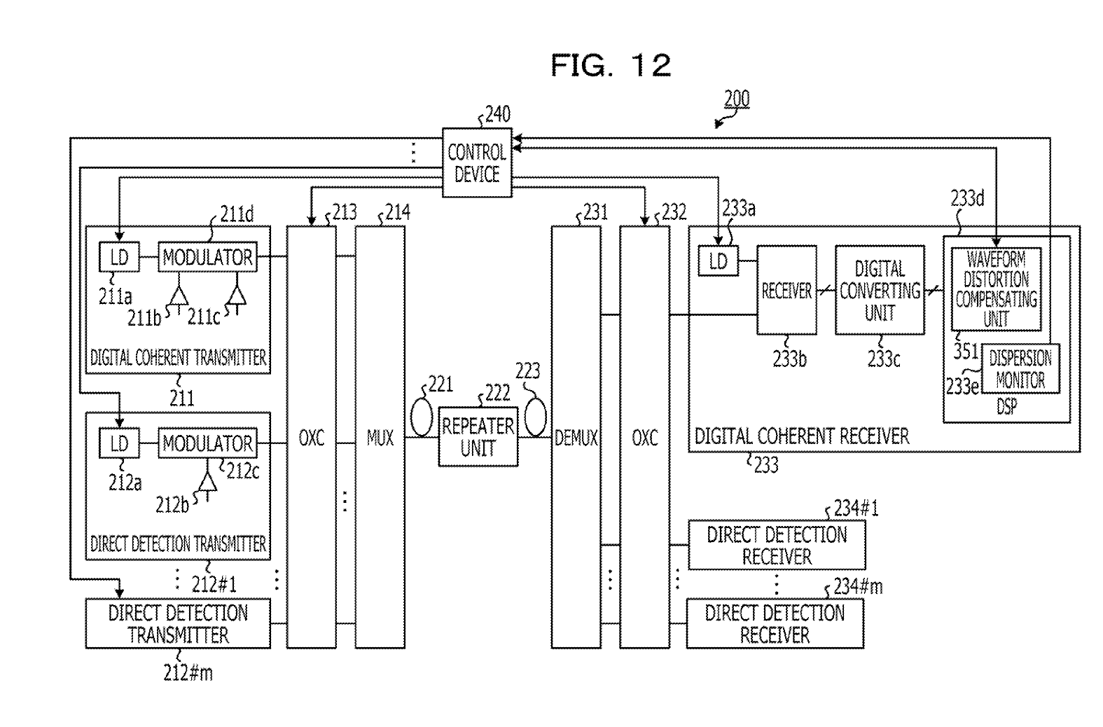

FIG. 12 is a diagram illustrating an example of the communication system according to a fourth embodiment. In FIG. 12, the components substantially similar to the components of FIG. 2 are indicated by the similar numerals, so that the description is omitted. As illustrated in FIG. 12, the DSP 233d of the digital coherent RX 233 has a function of the waveform distortion compensating unit 351 (see FIG. 3). The waveform distortion compensating unit 351 is a digital filter that has a function of the chromatic dispersion compensation circuit 400 illustrated in FIG. 4.

The control device 240 sets the wavelength of the optical signal, which is transmitted from the digital coherent TX 211, to the wavelength of which the amount of the accumulated chromatic dispersion of the optical signal received by the digital coherent RX 233 is lower than the prescribed value, and decreases the number of filter stages of the waveform distortion compensating unit 351. For example, in the processing performed by the chromatic dispersion compensation circuit 400 illustrated in FIG. 4, the control device 240 decreases the number of filter stages, n. As a result, the processing amount of the waveform distortion compensating unit 351 is reduced, so that the power consumption of the digital coherent RX 233 may be reduced.

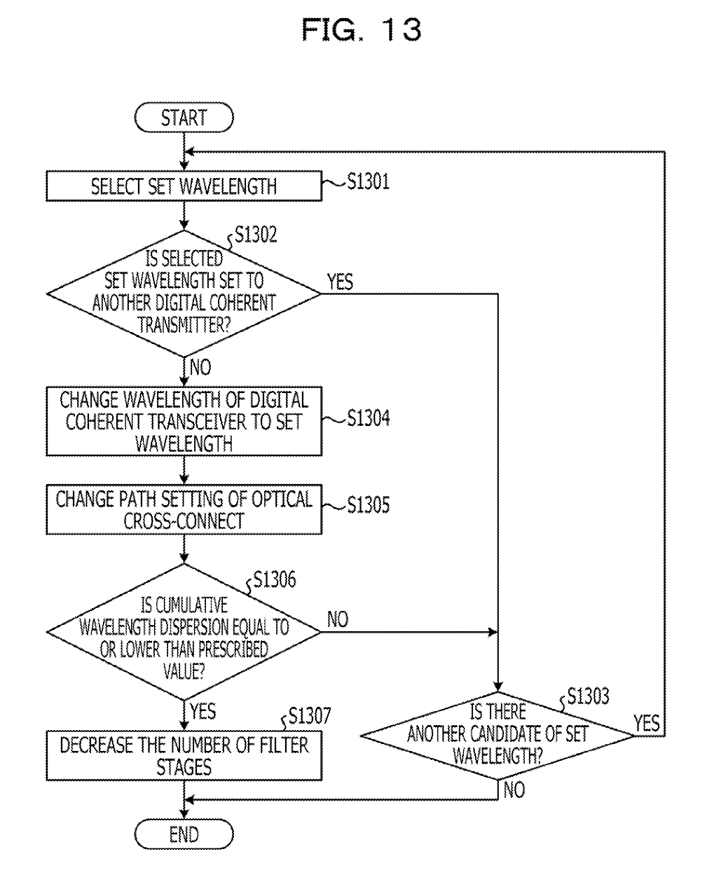

FIG. 13 is a flowchart illustrating an example of the control processing by the control device according to the fourth embodiment. The control device 240 performs Operations illustrated in FIG. 13 on the pair of the digital coherent TX 211 and the digital coherent RX 233. Operations S1301 to S1306 illustrated in FIG. 12 are substantially similar to Operations S501 to S506 illustrated in FIG. 5. After Operation S1306, the control device 240 decreases the number of filter stages of the waveform distortion compensating unit 351 (Operations S1307), and the sequence processing ends.

In this manner, according to the communication system 200 of the fourth embodiment, the wavelength of the optical signal transmitted from the digital coherent TX 211 may be set to the wavelength of which the amount of the accumulated chromatic dispersion of the optical signal received by the digital coherent reception device 233 is equal to or lower than the prescribed value. The number of filter stages of the waveform distortion compensating unit 351 may be decreased in a state where the amount of the accumulated chromatic dispersion of the optical signal received by the reception device 120 is equal to or lower than the prescribed value. As a result, the power consumption of the digital coherent RX 233 may be reduced while the decrease of the transmission quality is substantially suppressed.

### Fifth Embodiment

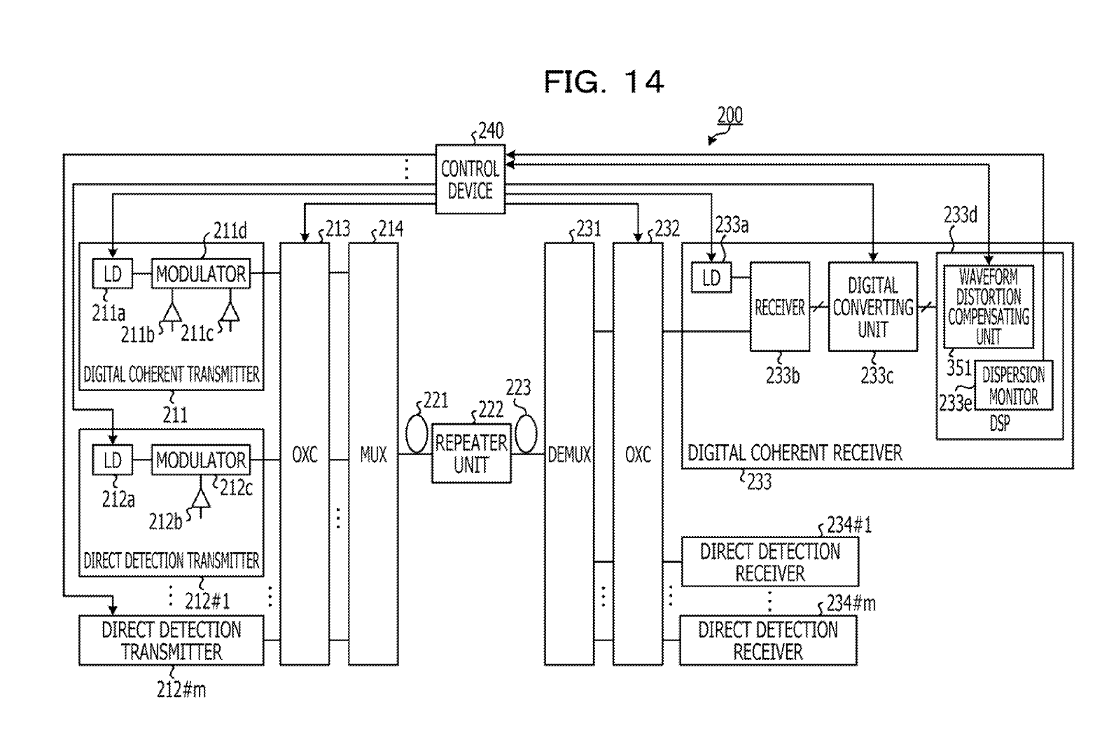

FIG. 14 is a diagram illustrating an example of the communication system according to the fifth embodiment. In FIG. 14, the components substantially similar to the components of FIG. 2 are indicated by the similar numerals, so that the description is omitted. As illustrated in FIG. 14, the DSP 233d of the digital coherent RX 233 has a function of the waveform distortion compensating unit 351. The waveform distortion compensating unit 351 is a digital filter that has a function of the chromatic dispersion compensation circuit 400 illustrated in FIG. 4. The control device 240 decreases the number of bits of the analog/digital converters 341 to 344 of the digital converting unit 233c and decreases the number of filter stages of the waveform distortion compensating unit 351.

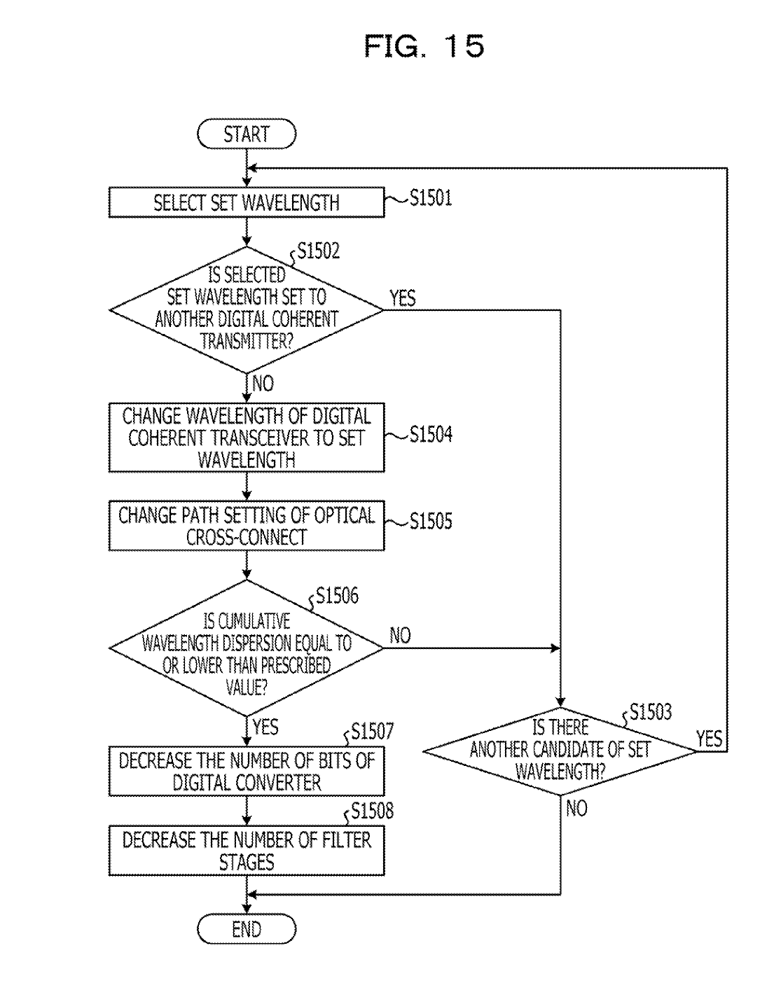

FIG. 15 is a flowchart illustrating an example of the control processing by the control device according to the fifth embodiment. The control device 240 performs Operations illustrated in FIG. 15 on the pair of the digital coherent TX 211 and the digital coherent RX 233. Operations S1501 to S1507 illustrated in FIG. 15 are substantially similar to Operations S501 to S507 illustrated in FIG. 5. After Operation S1507, the control device 240 decreases the number of filter stages of the waveform distortion compensating unit 351 (Operation S1508), and the sequence processing ends.

In this manner, according to the communication system 200 of the fifth embodiment, the wavelength of the optical signal transmitted from the digital coherent TX 211 may be set to the wavelength of which the amount of the accumulated chromatic dispersion of the optical signal received by the digital coherent RX 233 is equal to or lower than the prescribed value. The number of the bits of the analog/digital converters 341 to 344 may be decreased in a state where the amount of the accumulated chromatic dispersion of the optical signal received by the reception device 120 is equal to or lower than the prescribed value. Furthermore, the number of filter stages of the waveform distortion compensating unit 351 may be decreased in a state where the amount of the accumulated chromatic dispersion of the optical signal received by the receiver device 120 is equal to or lower than the prescribed value. As a result, the power consumption of the digital coherent RX 233 may be reduced while the decrease of the transmission quality is substantially suppressed.

### Sixth Embodiment

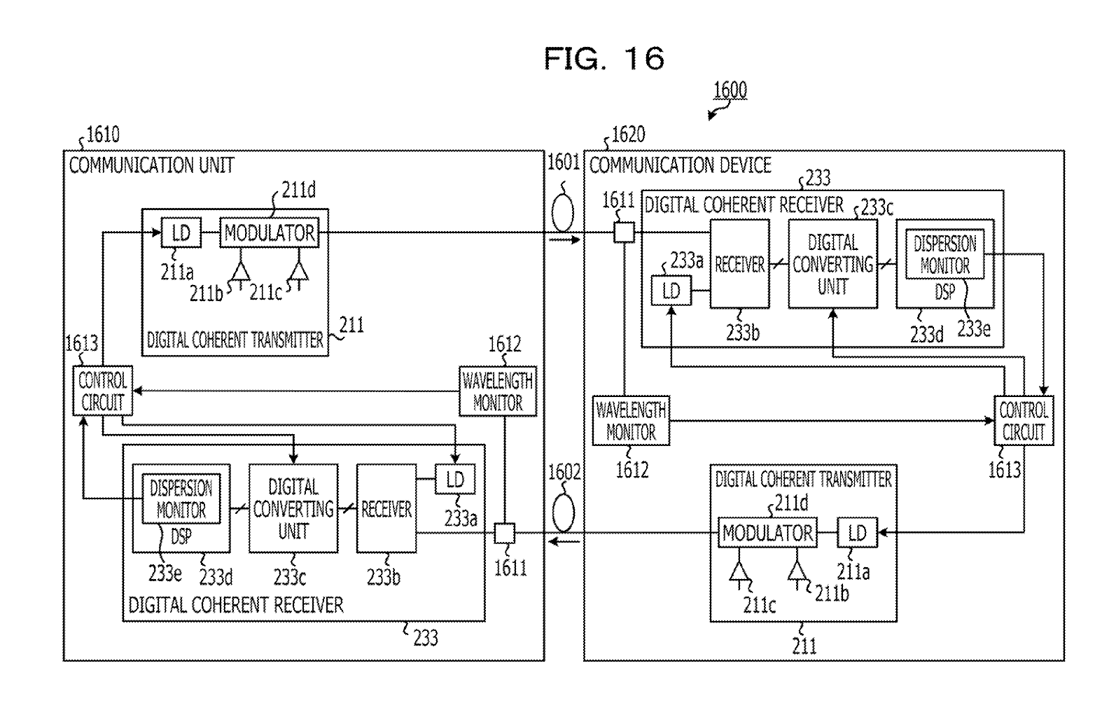

FIG. 16 is a diagram illustrating an example of the communication system according to the sixth embodiment. In FIG. 16, the components substantially similar to the components of FIG. 2 are indicated by the similar numerals, so that the description is omitted. As illustrated in FIG. 16, the communication system 1600 according to the sixth embodiment includes a communication device 1610 and a communication device 1620. The communication device 1610 and the communication device 1620, which are facing each other, transmit and receive the optical signals. Specifically, the communications device 1610 and the communication device 1620 include the digital coherent TX 211, the digital coherent RX 233, the branch unit 1611, the wavelength monitor 1612, and the control circuit 1613, respectively.

The digital coherent TX 211 of each of the communication devices 1610 and 1620 transmits the optical signal to the opposing communication device. For example, the digital coherent TX 211 of the communication device 1610 transmits the optical signal to the communication device 1620 through a transmission path 1601. The digital coherent TX 211 of the communication device 1620 transmits the optical signal to the communication device 1610 through a transmission path 1602. The LD 211a of each of the communication devices 1610 and 1620 changes the wavelength of the light under the control of the control circuit 1613.

The branch unit 1611 of each of the communication devices 1610 and 1620 braches the optical signal transmitted from the opposing communication device and outputs the branched optical signal to the digital coherent RX 233 and the wavelength monitor 1612. The digital coherent RX 233 of each of the communications 1610 and 1620 receives the optical signal output from the branch unit 1611. The LD 233a of each of the communication devices 1610 and 1620 changes the wavelength of the local oscillation light under the control of the control circuit 1613.

The digital converting unit 233c of each of the communication devices 1610 and 1620 decreases the number of bits of the analog/digital converters 341 to 344 under the control of the control circuit 1613. The dispersion monitor 233e of each of the communication devices 1610 and 1620 outputs the dispersion information indicating the monitored accumulated chromatic dispersion to the control circuit 1613. The wavelength monitor 1612 of each of the communication devices 1610 and 1620 monitors the wavelength of the optical signal output from the branch unit 1611 and outputs the wavelength information indicating the monitored wavelength to the control circuit 1613.

The control circuit 1613 of each of the communication devices 1610 and 1620 is an example of the control circuit 130 illustrated in FIG. 1. Based on the accumulated chromatic dispersion indicating the dispersion information output from the dispersion monitor 233e and on the wavelength indicated by the wavelength information output from the wavelength monitor 1612, the control circuit 1613 controls the wavelengths of the LD 211a and 233a and the number of bits of the digital converting unit 233c.

Specifically, if the accumulated chromatic dispersion indicated by the dispersion information does not meet the prescribed condition, the control circuit 1613 sets the wavelength of the LD 211a to the wavelength that is different from the wavelength indicated by the wavelength information. Furthermore, the control circuit 1613 sets the wavelength of the LD 211a to the wavelength indicated by the wavelength information and decreases the number of bits of the digital converting unit 233c.

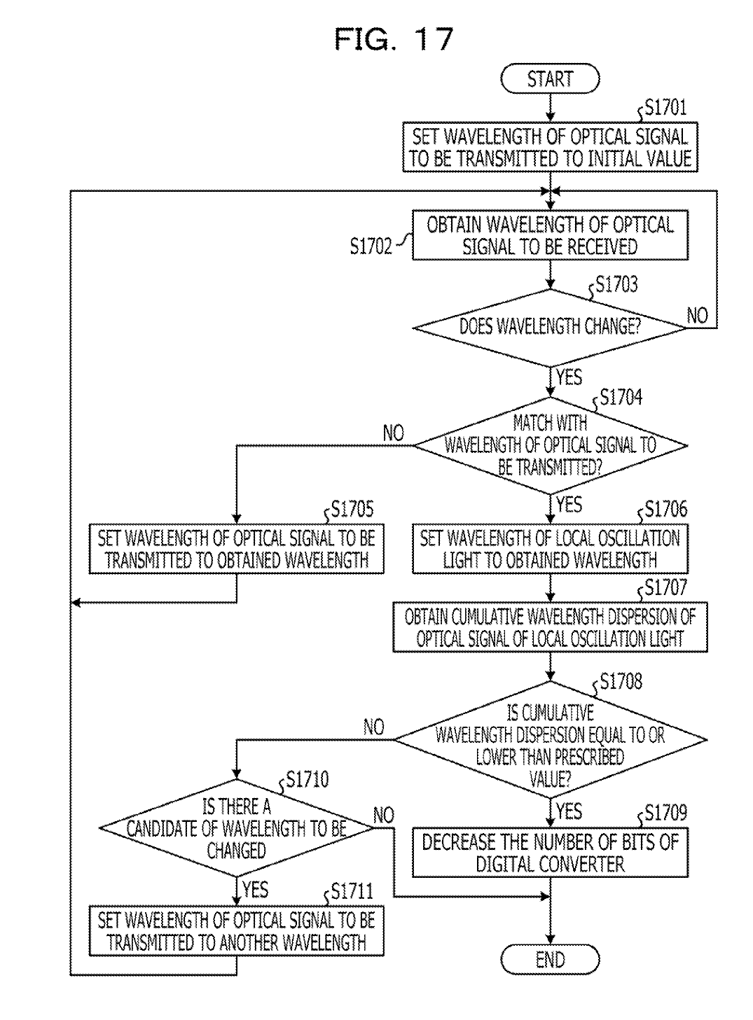

FIG. 17 is a flowchart (1) illustrating an example of the control processing by the control circuit according to the sixth embodiment. The control circuit 1613 of the communication device 1610 controls each configuration of the communication device 1610 by performing Operations illustrated in FIG. 17, for example. The control circuit 1613 sets the wavelength (the wavelength of the LD 211a) of the optical signal transmitted from the digital coherent TX 211 to an initial value (Operation S1701).

The control circuit 1613 obtains, from the wavelength monitor 1612, the wavelength of the optical signal received from the communication device 1620 (Operation S1702). The control circuit 1613 determines whether or not the wavelength obtained in Operation S1702 changes from the wavelength obtained in Operation S1702 (Operation S1703). If the wavelength does not change (No in Operation S1703), the control circuit 1613 goes back to Operation S1702. If the wavelength changes (Yes in Operation S1703), the control circuit 1613 determines whether or not the wavelength obtained in Operation S1702 matches the wavelength of the optical signal transmitted from the digital coherent TX 211 (Operation S1704).

In Operation S1704, if the wavelengths do not match with each other (No in Operation S1704), the control circuit 1613 goes to Operation S1705. Specifically, the control circuit 1613 sets the wavelength (the wavelength of the LD 211a) of the optical signal transmitted from the digital coherent TX 211 to the wavelength obtained in Operation S1702 (Operation S1705), and the process goes back to Operation S1702.

In Operation S1704, if the wavelengths match with each other (Yes in Operation S1704), the control circuit 1613 sets the wavelength of the local oscillation light output from the LD 233a to the wavelength obtained in Operation S1702 (Operation S1706). The control circuit 1613 obtains, from the dispersion monitor 233e, the accumulated chromatic dispersion of the optical signal received from the communication device 1620 (Operation S1707).

The control circuit 1613 determines whether or not the accumulated chromatic dispersion obtained in Operation S1707 is equal to or lower than the prescribed value (Operation S1708). If the accumulated chromatic dispersion is equal to or lower than the prescribed value (Yes in Operation S1708), the control circuit 1613 decreases the number of bits of the analog/digital converters 341 to 344 of the digital converting unit 233c, and the sequence processing ends. If the accumulated chromatic dispersion is not equal to or lower than the prescribed value (No in Operation S1708), the control circuit 1613 determines whether or not there is a candidate of the wavelength to be changed for the LD 211a (Operation S1710).

In Operation S1710, if there is no candidate of the wavelength (No in Operation S1710), the control circuit 1613 ends the processing. If there is a candidate of the wavelength (Yes in Operation S1710), the control circuit 1613 changes the wavelength of the optical signal transmitted from the digital coherent TX 211 into the wavelength that is different from the wavelength of the communication device 1620 (Operation S1711), and the sequence processing ends. Specifically, the control circuit 1613 changes the wavelength of the LD 211a into the wavelength that is different from the wavelength obtained in Operation S1702.

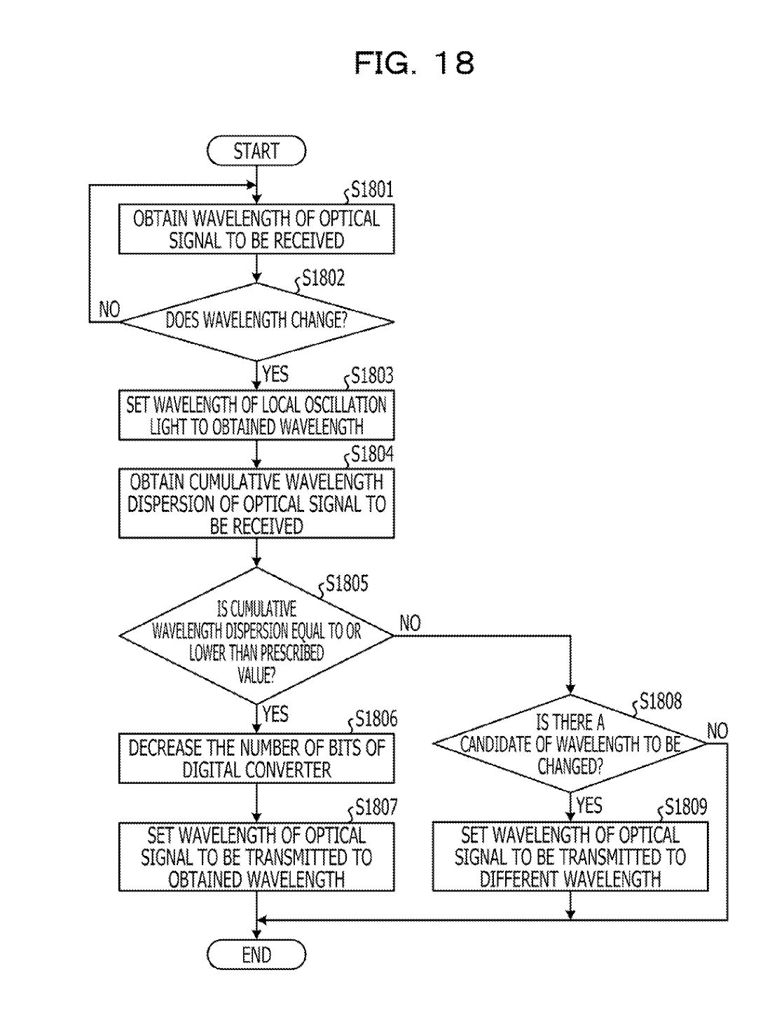

FIG. 18 is a flowchart (2) of an example of the control processing by the control circuit according to the sixth embodiment. The control circuit 1613 of the communication device 1620 controls the configuration of the communication device 1620 by performing Operations illustrated in FIG. 18. The control circuit 1613 obtains, from the wavelength monitor 1612, the wavelength of the optical signal received by the communication device 1620 (Operation S1801). The control circuit 1613 determines whether or not the wavelength obtained in Operation S1801 changes from the wavelength obtained in Operation S1801 (Operation S1802).

If the wavelength does not change in Operation S1802 (No in Operation S1802), the control circuit 1613 goes back to Operation S1801. If the wavelength changes (Yes in Operation S1802), the control circuit 1613 sets the wavelength of the local oscillation light output from the LD 233a to the wavelength obtained in Operation S1801 (Operation S1803). The control circuit 1613 obtains, from the dispersion monitor 233e, the accumulated chromatic dispersion of the optical signal received by the communication device 1620 from the communication device 1610 (Operation S1804).

The control circuit 1613 determines whether or not the accumulated chromatic dispersion obtained in Operation S1804 is equal to or lower than the prescribed value (Operation S1805). If the accumulated chromatic dispersion is equal to or lower than the prescribed value (Yes in Operation S1805), the control circuit 1613 decreases the number of bits of the analog/digital converters of the digital converting unit 233c (Operation S1806). The control circuit 1613 sets the wavelength (the wavelength of the LD 211a) of the optical signal transmitted from the digital coherent TX 211 to the wavelength obtained in Operation S1801, and the sequence processing ends.

If the accumulated chromatic dispersion is not equal to or lower than the prescribed value in Operation S1805 (No in Operation S1805), the wavelength monitor 1612 determines whether or not there is a candidate of the wavelength to be changed for the LD 211a (Operation S1808). The candidate of the wavelength to be changed for the LD 211a is the wavelength that is different from the wavelength obtained in Operation S1801. If there is no candidate of the wavelength (No in Operation S1808), the control circuit 1613 ends the processing.

If there is a candidate of the wavelength in Operation S1808 (Yes in Operation S1808), the control circuit 1613 changes the wavelength of the optical signal transmitted from the digital coherent TX 211 into the wavelength that is different from the wavelength of the communication device 1610 (Operation S1809), and the sequence processing ends. Specifically, the control circuit 1613 changes the wavelength of the LD 211a into the wavelength that is different from the wavelength obtained in Operation S1801.

By repeating Operations illustrated in FIG. 17 and FIG. 18, if the accumulated chromatic dispersion of the reception signal is higher than the prescribed value, the control circuit 1613 of each of the communication devices 1610 and 1620 may set the transmission wavelength to the wavelength that is different from the reception wavelength. As a result, the transmission wavelength of each of the communication devices 1610 and 1620 may be set to the wavelength so that the accumulated chromatic dispersion of the reception signal of each of the communication devices 1610 and 1620 is equal to or lower than the prescribed value.

As a result, even if the each of the communication devices 1610 and 1620 does not transmit or receive the control signal indicating that the wavelength is desired to be set, each of the communication devices 1610 and 1620 may set the transmission wavelength to the wavelength of which the accumulated chromatic dispersion is equal to or lower than the prescribed value. Furthermore, if the transmission wavelength of each of the communication devices 1610 and 1620 is set to the wavelength of which the accumulated chromatic dispersion of the reception signal of each of the communication devices 1610 and 1620 is equal to or lower than the prescribed value, the power consumption of the digital coherent RX 233 may be reduced.

According to the communication system 1600 of the sixth embodiment, the communication between the communication device 1610 and the communication device 1620 may achieve the effect that is substantially similar to the second embodiment. Even if each of the communication devices 1610 and 1620 does not transmit or receive the control signal indicating that the wavelength is desired to be set, each of the communication devices 1610 and 1620 may set the transmission wavelength to the wavelength of which the accumulated chromatic dispersion is equal to or lower than the prescribed value. Accordingly, a simple configuration may reduce the power consumption of the digital coherent RX 233 while the decrease of the transmission quality is substantially suppressed.

The communication system 1600 according to the sixth embodiment may be combined with the communication system 200 according to the above-described embodiments. For example, in the communication devices 1610 and 1620 of the communication system 1600, the control circuit 1613 may reduce the power consumption of the digital coherent RX 233 by decreasing the number of filter stages of the waveform distortion compensating unit 351.

The digital signal processor, which is a processor such as a DSP, may include a processor, a logical circuit, and a Field-Programmable Gate Array (FPGA) and the like. The control circuit may include a processor, a logical circuit, and a Field-Programmable Gate Array (FPGA) and the like.

According to the disclosed control circuit, communication system, and control method, the power consumption of the receiver device may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the invention have been described in detail, it should be understood that the various changes, substitutions, and alterations could be made hereto without departing from the spirit and scope of the invention.

What is claimed is:

1. A communication system comprising:
a transmitter that transmits an optical signal;
a receiver device that receives the optical signal; and
a control circuit that reduces a power consumption of the receiver device based on an accumulated chromatic dispersion of the received optical signal,
the receiver device including,
a receiver that extracts a signal indicating a complex amplitude of the optical signal,
an analog/digital converter that converts the signal indicating the complex amplitude into a digital signal, and
a digital signal processor that digitally-processes the digital signal.

2. The communication system according to claim 1, wherein the control circuit controls a wavelength of the optical signal which is transmitted from the transmitter based on the accumulated chromatic dispersion.

3. The communication system according to claim 1, wherein
the control circuit controls at least one of the analog/digital converter and the digital signal processor so that the power consumption is reduced.

4. The communication system according to claim 1, wherein
the receiver device further includes,
a hybrid circuit that combines the optical signal with a local oscillation light;
an optical/electric converter that converts the combined optical signal into an electric signal; and
wherein the control circuit controls the wavelength of the local oscillation light according to the wavelength of the optical signal.

5. The communication system according to claim 3, wherein the control circuit controls a resolution of the analog/digital converter.

6. The communication system according to claim 3, wherein the digital signal processor reduces a waveform distortion due to a chromatic dispersion of the signal converted by the analog/digital converter, and
wherein the control circuit controls a number of filter stages of the digital filter processing.

7. The communication system according to claim 2, wherein the control circuit controls a wavelength of the optical signal which is transmitted by the transmitter so that an amount of the accumulated chromatic dispersion is equal to or less than a first value.

8. The communication system according to claim 2, wherein the control circuit is provided in the receiver device, and
wherein the receiver device transmits a control signal to the transmitter and the control circuit controls the wavelength of the optical signal which is transmitted by the transmitter based on the control signal.

9. The communication system according to claim 2, wherein the control circuit is provided in the transmitter, and
wherein the control circuit transmits a control signal to the receiver device and the control circuit controls the receiver device so that the power consumption of the receiver device is reduced.

10. The communication system according to claim 2, wherein the control circuit is provided in a communication device that is different than the transmitter and the receiver device,
wherein the receiver device transmits a control signal to the transmitter and the control circuit controls the wavelength of the optical signal which is transmitted by the transmitter based on the control signal, and
the control circuit transmits a control signal to the receiver device and the control circuit controls the receiver device so that the power consumption of the receiver device is reduced.

11. The communication system according to claim 3, wherein the digital signal processor monitors the accumulated chromatic dispersion, and
wherein the control circuit obtains the monitored accumulated chromatic dispersion.

12. The communication system according to claim 2, further comprising:
a first optical cross connect which comprises a plurality of input ports into which the optical signal, which is transmitted from the transmitter is input, a plurality of output ports, and a light having a wavelength that is different than the wavelength of the optical signal are input; and
a multiplexer which includes the plurality of input ports corresponds to each of the wavelengths coupled with the plurality of output ports, and
wherein the control circuit controls a path of the first optical cross connect so that the optical signal is input into the input port of the multiplexer corresponding to the set wavelength.

13. The communication system according to claim 2, further comprising:
a demultiplexer which wavelength-demulitiplexes the wavelength-multiplexed light which is wavelength-multiplexed by a multiplexer, and
a second optical cross connect which comprises a plurality of input ports into which the light, which is wavelength-multiplexed by the demultiplexer is input, and a plurality of output ports which includes the output port coupled with the receiver device, and
wherein the control circuit controls the path of the second optical cross connect so that the optical signal output from the output port of the multiplexer corresponding to the set wavelength is output to the receiver device.

14. The communication system according to claim 2, further comprising:
a first optical coupler which multiplexes the light transmitted from the transmitter with the light having the wavelength that is different than the wavelength of the optical signal.

15. A control circuit comprising:
an obtain circuit which obtains an accumulated chromatic dispersion of an optical signal which is received by a receiver device; and
a power saving control circuit which reduces a power consumption of the receiver device based on the obtained accumulated chromatic dispersion.

16. The control circuit according to claim 15, further comprising: a wavelength control circuit that controls a wavelength of the optical signal which is transmitted from a transmitter based on the accumulated chromatic dispersion.

17. The control circuit according to claim 15, wherein the receiver device includes,
a receiver that extracts a signal indicating a complex amplitude of the optical signal,
an analog/digital converter that converts the signal indicating the complex amplitude into a digital signal, and
a digital signal processor that digitally-processes the digital signal, and
wherein the power saving control circuit controls at least one of the analog/digital converter and the digital signal processer so that the power consumption is reduced.

18. The control circuit according to claim 16, wherein
the receiver device further includes,
a hybrid circuit that combines the optical signal with a local oscillation light; and
an optical/electric converter that converts the combined optical signal into an electric signal, and
wherein the wavelength control circuit controls the wavelength of the local oscillation light according to the wavelength of the optical signal.

19. A control method comprising:
obtaining an accumulated chromatic dispersion of an optical signal which is received by a receiver device; and
reducing a power consumption of the receiver device based on the accumulated chromatic dispersion.

20. The control method according to claim 19, wherein the control method controls a wavelength of the optical signal which is transmitted from a transmitter based on the accumulated chromatic dispersion.
